(19) United States
(12) Patent Application Publication
(10) Pub. No.: US 2016/0303590 A1
(43) Pub. Date: Oct. 20, 2016

(54) Systems and Methods for Portable Multi-Component Mixing of Materials for Spray Application of Same

(71) Applicant: SealantTech, Las Vegas, NV (US)

(72) Inventor: William Davis Collins, Fayetteville, AR (US)

(73) Assignee: SealantTech, Las Vegas, NV (US)

(21) Appl. No.: 15/197,998

(22) Filed: Jun. 30, 2016

Related U.S. Application Data
(63) Continuation-in-part of application No. 14/627,118, filed on Feb. 20, 2015.
Application No. 14/627,118 is a continuation-in-part of application No. 13/186,648, filed on Jul. 20, 2011, now Pat. No. 8,960,567.

(51) Int. Cl. B05B 7/00; B05B 7/16; B05D 1/02; B05D 5/00; B01F 3/04; B01F 5/12

(52) U.S. Cl. CPC B05B 7/0093; B01F 3/04446; B01F 5/12; B05D 1/02; B05D 5/00; B05B 7/1693

(57) ABSTRACT

Methods, systems and an apparatus for single-component or multi-component mixing and spray application, including a portable frame, heated chemical hose, and a high-precision pump for providing fast-curing, variable-density foams.

### CROSS-REFERENCE TO RELATED APPLICATIONS

This application is a continuation-in-part of U.S. patent application Ser. No. 14/627,118, filed Feb. 20, 2015, which is a continuation-in-part of U.S. patent application Ser. No. 13/186,648, filed Jul. 20, 2011, which are expressly incorporated herein by reference in their entirety.

### BACKGROUND OF THE INVENTION

1. Field of the Invention

The present invention relates to air barrier products. Furthermore, the present invention relates to multi-layer air barrier products for application to building enclosures, walls and HVAC systems and to systems and methods relating thereto.

2. Description of the Prior Art

It is known in the relevant art to provide plural component proportioners and mixers for mixing materials including polyurethane and polyurea that are portable, i.e., including wheels for manually manipulating the proportioner to another location. Examples of relevant art publications include the following:

US Patent Application Publication No. 20060071022 and PCT Publication No. WO/2004042484 for Fast Set Material Proportioner assigned according to the publication document as printed to Graco Minnesota, Inc. describing an electrically powered plural component proportioner that is transportable.

US Patent Application Publication No. 20060144447 for Electronic proportioner using continuous metering and correction assigned according to the publication document as printed to Graco Minnesota, Inc. disclosing a method for dispensing materials in a plural component proportioner and illustrating a wheeled frame.

US Patent Application Publication No. 20050023296 for Heated pump system for delivering multiple components in a predetermined ratio to a spray application by Bien describing a portable chemical proportioner with means for heating the chemical components, namely the use of heated hoses for application of the components, which may be drawn from chemical drums, and wherein the system may be transported on a frame that includes castors or other wheel assemblies for moving the system.

U.S. Pat. No. 4,809,909 for Plural component application system & U.S. Pat. No. 5,294,052 for Fluid dispensing system assigned according to the publication document to Glas-Craft Inc. describing a plural component application system for polyurethane applications, the system including means for heating the component materials and being mounted on a wheeled base.

US Patent Application Publication No. 20050236422 for Portable apparatus for mixing and dispensing viscous materials by inventor Dutton disclosing a device for mixing and dispensing plural component materials, including at least two reservoirs for holding component materials and means for heating the materials, namely using heated hoses for dispensing components, and further describing a housing on wheels for containing the reservoirs and other aspects of the device.

U.S. Pat. No. 3,786,990 for a Plural component gun assigned according to the patent publication document to Graco Inc., by inventor Hagfors, disclosing a plural component spray gun and spraying system incorporating thermal insulated heated hoses and a support structure with a handle, bracing, and wheels that may be used to transport the system. [ONO] U.S. Pat. No. 4,332,498 for a sealant applicator invented by Lewis describing a sealant applicator for applying an elastomeric sealant made by mixing two components, and means for heating the components, and further describing a frame supported on wheels for moving the frame.

U.S. Pat. No. 6,896,152 and US Patent Application Publication No. 20030015547 for Electronic plural component proportioner, assigned according to the patent document to Graco Minnesota, Inc. by inventors Pittman and Friedrich disclosing an apparatus for dispensing plural component materials illustrated as being supplied by a bucket, wherein the apparatus appears to be constructed and positioned on a wheeled platform stand.

U.S. Pat. No. 6,663,016 and US Patent Application Publication Nos. 20030062427 and 20040227006 for an Applicator assembly for application of adhesives, sealants, and coatings assigned to Urecoats Technologies, Inc. according to the patent document by inventor Bien, describing an applicator system for melting, mixing, and applying a composition of one or more materials, and a heating system for heating components using heated hoses, the system being supported on a wheeled frame that is towable behind a vehicle.

U.S. Pat. No. 3,194,438 for a Cleaning and sanitizing machine, invented by Maurice D. Walker and Jimmie K. Sanders, describing a portable machine designed for cleaning and sterilizing food plants, washing automobiles, degreasing automobile motors and machines; which will utilize or take a desired amount of chemical cleaner or concentrate and dispense same at a desired ratio into a water hose leading to a nozzle; also will direct air under pressure which is added at the nozzle to give increased force to the stream of water.

U.S. Pat. No. 5,093,896 for a System for transporting highly viscous waterproofing membrane assigned to Pacific Rainier Roofing, Inc., described as a system for transporting liquefied, highly viscous waterproofing membrane from a kettle where the membrane is heated and stored to a remote location. The system comprises a pump assembly for pumping membrane out of a kettle, a pipe assembly coupled with the pump assembly for providing a passageway along which the membrane may be transported from the pump assembly to an intermediate location, and a lugger for receiving membrane discharged from the pipe assembly and for transporting the membrane to the remote location. The pipe assembly and the lugger include heating devices for maintaining the temperature of membrane being transported thereby at a selected temperature, typically in the range of 375.degree. F. to 425.degree. F.

U.S. Pat. No. 6,571,805 for a Multi-container pressure washer and related product selecting valve assigned to Briggs & Stratton Power Products Group, Llc, described as a pressure washer which includes a chassis as well as a liquid pump, a pump-driving prime mover, plural chemical product containers and a product selecting valve, all supported by the chassis. Each of the containers is attached to a separate valve conduit extending to the valve and the valve is connected to a device conduit extending to the mixing device. A distributor is mounted for movement with respect to the valve body and has a channel for selectively connecting one of the valve conduits to the device conduit.

US Patent Application Publication No. 2003/0192963 for an Application apparatus for multiple solution cleaner, described by inventor Ebberts as a pressurized system for the preparation and mixing of two or more component solutions comprising a cleaning solution to produce a prepared cleaning solution for use with various applicators in common use in the cleaning industry. The system is made up of a mobile frame for supporting a plurality of pressurized tanks which are connected through feed lines to a mixing tee fitting to produce the output mixed cleaning solution. An inline heater is optionally added in one or more of the feed lines to provide heat to the component solution before mixing, and an inline heater is optionally added after mixing to heat the prepared solution. Pressure is supplied to the system by an air compressor directly connected to each of the pressurized tanks so that the same pressure is applied to all tanks.

U.S. Pat. No. 8,132,693 for an Adhesive dispenser system assigned to Handy & Harman and described as a dispenser system employing a packaging module for use with moisture sensitive materials. The packaging module comprises an outer carton and an inner bladder, which is substantially impermeable to moisture and is filled with one part of an adhesive. The carton is loaded on a mobile cart and the one part adhesive is supplied to a pump/mixer without exposure to moisture in the atmosphere.

Thus, the relevant prior art describes chemical proportioners supported by wheeled carts or frames, including dispensing or mixing systems with heated hoses.

### SUMMARY OF THE INVENTION

The present invention relates to component proportioners for mixing materials, and more particularly, to portable plural component mixers for mixing materials for spray application of polyurethane and polyurea chemicals.

It is an object of this invention to provide methods, systems and an apparatus for multi-component mixing and spray application, including a portable frame assembly with a precision 1:1 dual component air pneumatic pump. The invention makes use of heated hoses so that the chemicals stay at the precise temperature for spraying. Also, this invention utilizes a hose temperature control and a temperature sensor so that the machine is adjustable according to the material that is sprayed. Another object of this invention is to provide a system for applying both high-pressure and low-pressure spray foams at high densities.

Accordingly, an embodiment of this invention is directed to an apparatus for multi-component mixing and spray application, including a portable frame assembly having a dual component pump.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a front perspective view of a multi-component spray apparatus according to the invention.

FIG. 2 illustrates a front view of the multi-component spray apparatus illustrated in FIG. 1.

FIG. 3 illustrates a rear view of the multi-component spray apparatus illustrated in FIGS. 1 and 2.

FIG. 4 illustrates a cut-away side view of the multi-component spray apparatus illustrated in FIGS. 1-3.

FIG. 5 illustrates a rear perspective view of the multi-component spray apparatus illustrated in FIG. 1-4.

FIG. 6 illustrates a top view drawing of the multi-component spray apparatus illustrated in FIGS. 1-5.

FIG. 7 illustrates a system according to the present invention.

FIG. 8 illustrates a suction hose assembly according to the present invention.

FIG. 9 illustrates a spray hose assembly according to the present invention.

FIG. 10 is a schematic representation of an example system for the present invention.

FIG. 11 illustrates a bottom view of the multi-component spray apparatus.

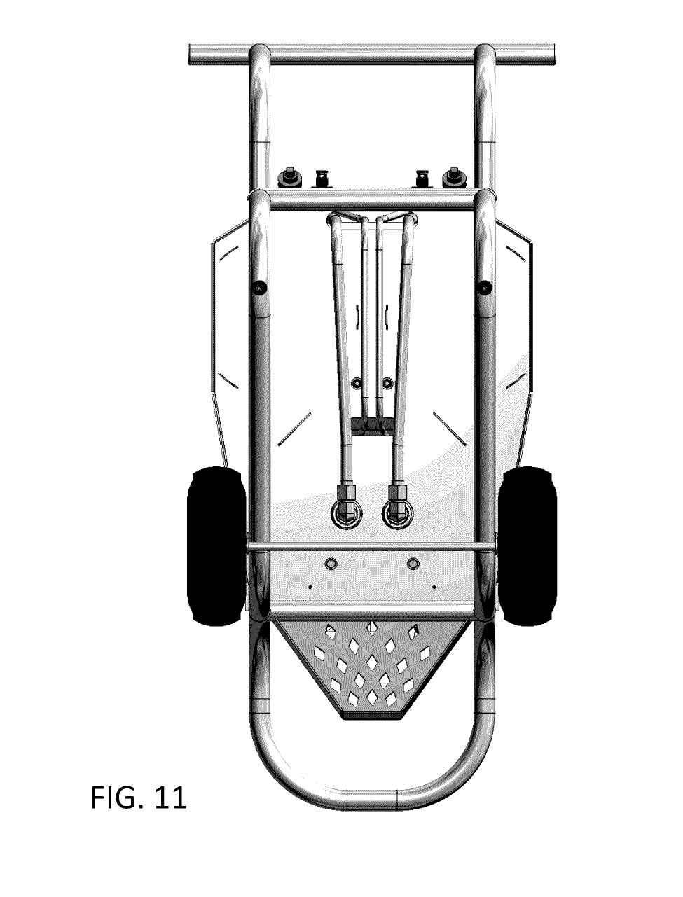

FIG. 12 illustrates a bottom perspective view of the multi-component spray apparatus.

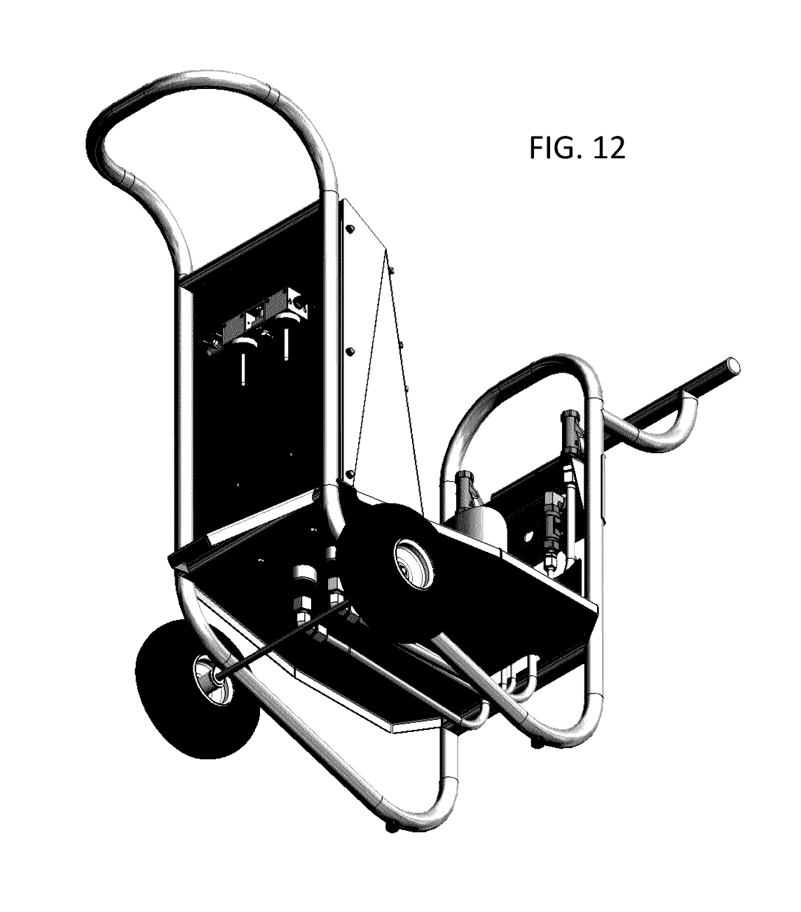

### DETAILED DESCRIPTION

Referring now to the drawings in general, the illustrations are for the purpose of describing a preferred embodiment of the invention and are not intended to limit the invention thereto.

The present invention provides systems, methods, and an apparatus for portable, multi-component mixing of materials for spray application, including spray polyurethane foam (SPF) and spray polyurea two component systems so that they react and mix once discharged from the gun. This mixing of “A” component ingredient which is polymeric isocyanate (MDI) and the “B” component which is a combination of polyols, blowing agents, catalysts, flame retardants and surfactants gives a finished product on the substrate which is it sprayed upon. In order to properly spray this type of chemistry, the equipment must be capable of storing, pumping, heating, mixing, and spraying these two components at the material suppliers recommended temperature, viscosity and material ratio. All of this action produces a product that is quick curing, has proper density, uniform consistency and minimal off-gassing including spray polyurethane foam (SPF) and spray polyurea two component systems.

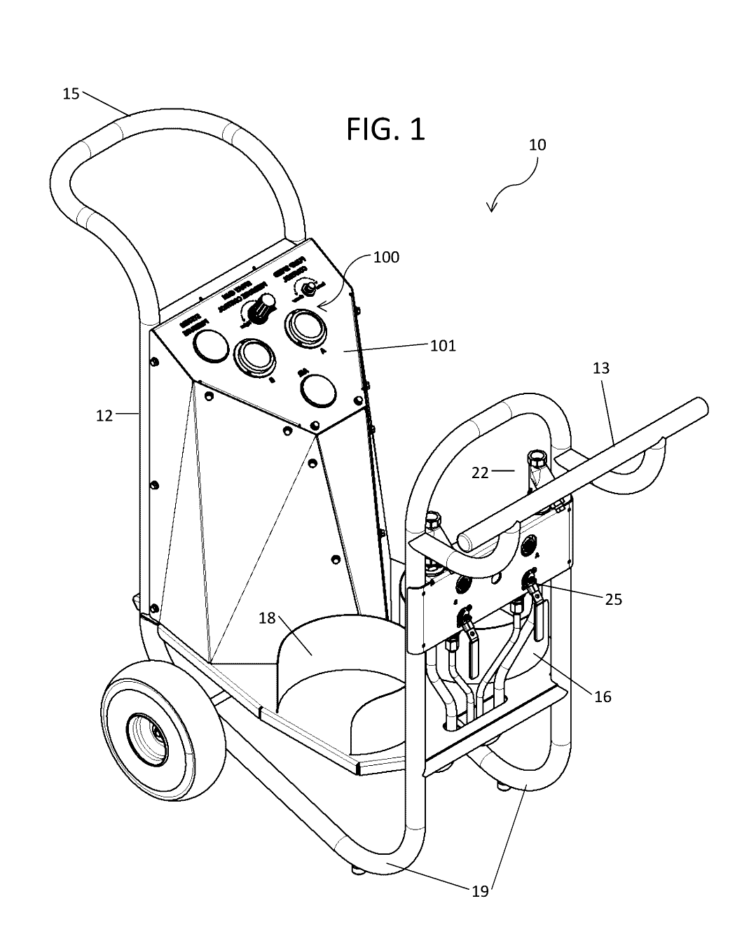

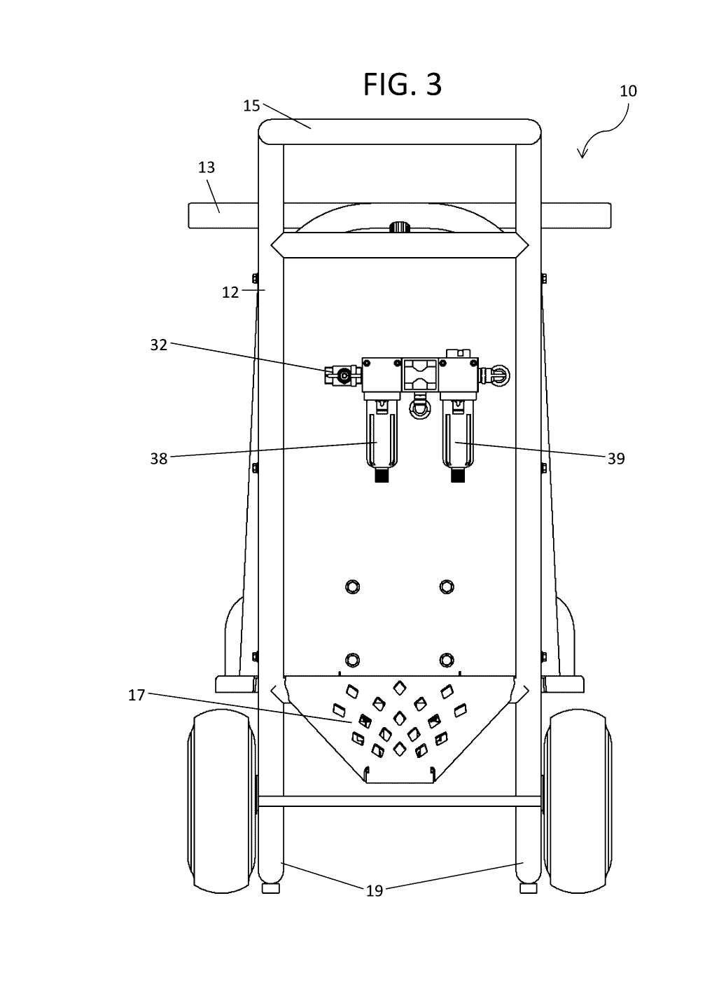

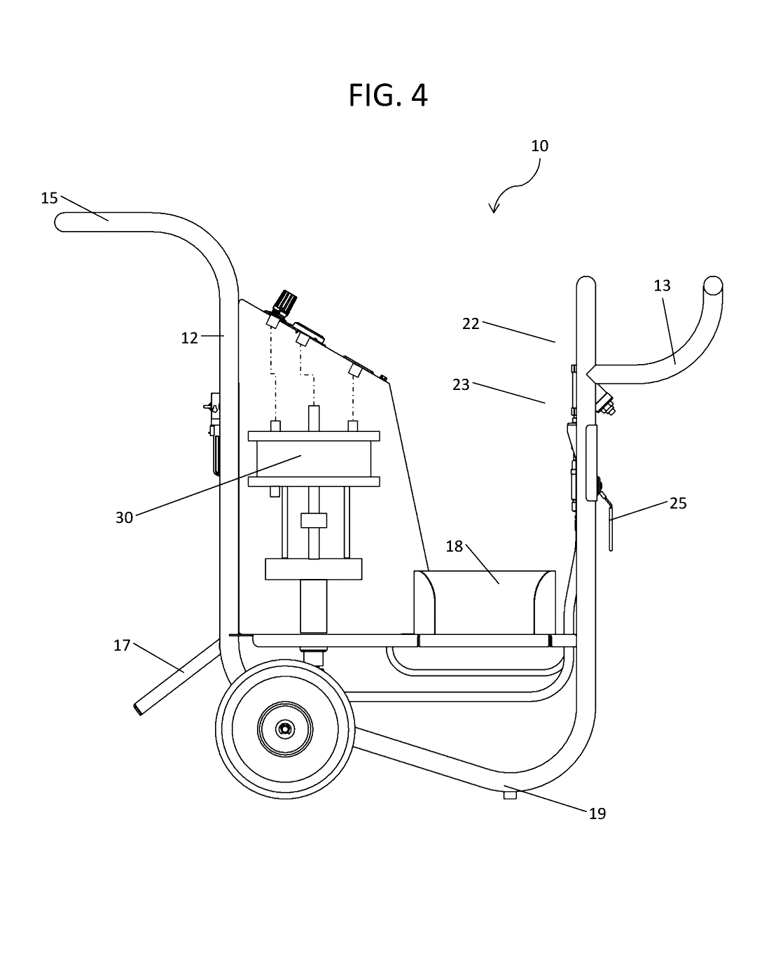

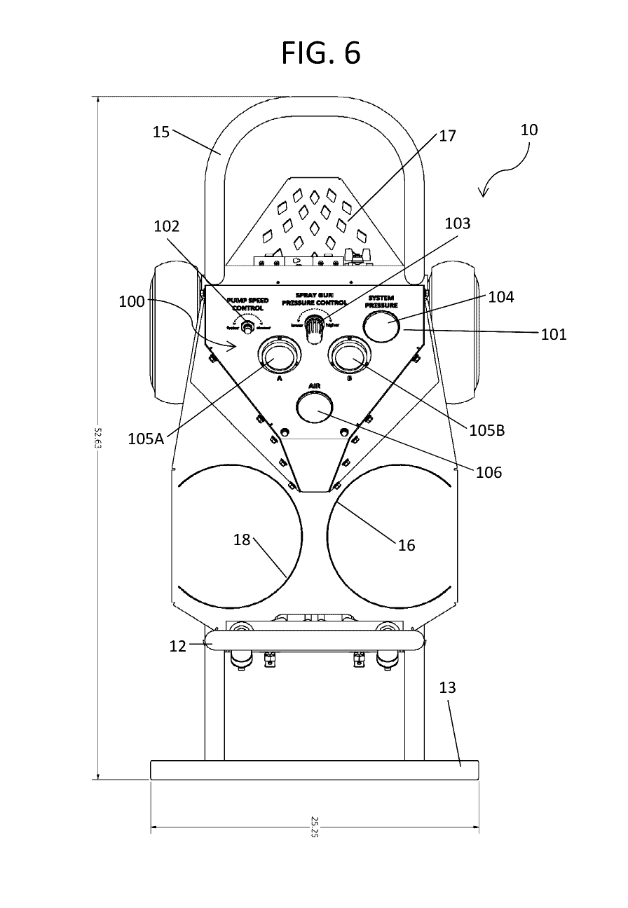

The equipment components necessary to spray apply these two component chemistries according to the present invention, generally described as 10 in FIGS. 1-6, includes a frame assembly 12; at least two container holders 16, 18; suction hose assembly 20, 21 for holding and withdrawing chemicals from containers (not shown); a high-precision mixing pump 30 (Shown in FIG. 4); a high pressure air supply connection 32 with at least one air filter 38; and controls 100.

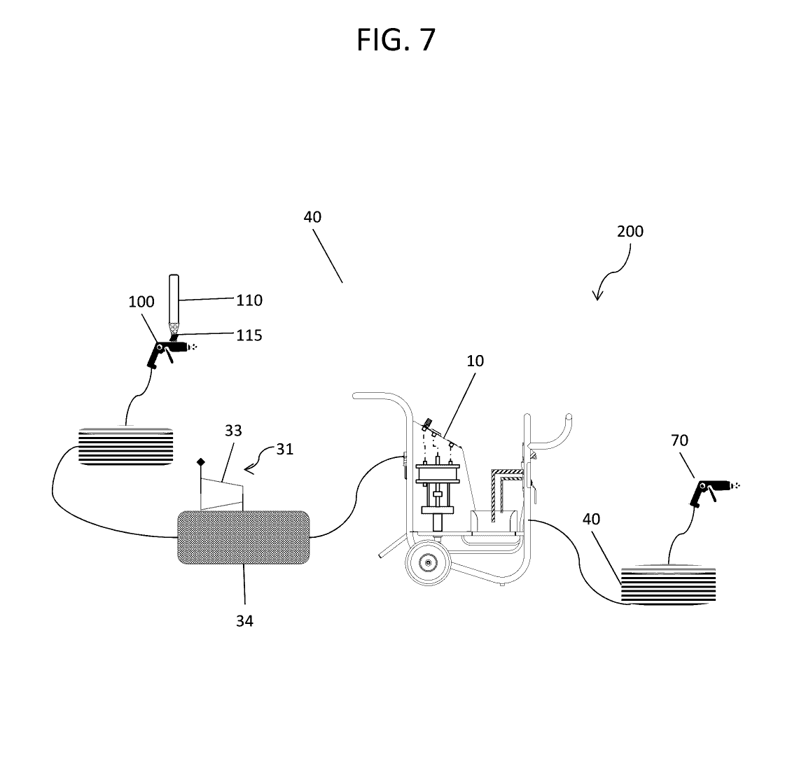

A two-component spray machine according to the present invention, generally shown as 200 in FIG. 7, includes the apparatus 10, and additionally a spray hose assembly 40, a spray gun 70, and a compressor system 31.

Frame Assembly

Referring to FIGS. 1-6, different views of an embodiment of the present invention are illustrated. The apparatus includes a frame assembly 12 designed and configured for easy transportation by 1 to 3 people. The frame assembly is sized to fit through standard residence openings. For example, in the United States, the frame assembly is sized to have a maximum width of 29 inches (737 mm), enabling it to fit through a standard residential doorway (30 inches/762 mm). Preferably, the frame assembly is about 25 inches (635 mm) wide and about 52 inches (1320 mm) long.

The frame assembly 12 is provided to support the various components attached thereto, including at least one, preferably two, spaced apart, generally symmetrical container holders 16, 18. The holders are constructed and configured for receiving replaceable materials containers that come in 5 gallon plastic pails or a similar type of storage device that carry liquids. The frame is also constructed and configured to provide support of the other components of the apparatus, including the mixing pump 30, air filter 38, and controls 100.

For portability and manipulation of the apparatus, the frame assembly includes an ergonomically positioned front handle 13 and rear handle 15 to enable simultaneous pushing and pulling, especially for when traversing difficult terrain and/or moving up/down inclines. The front handle 13 is preferably designed so that two people use it to pull the apparatus. The frame assembly also preferably includes a pedal 17, which provides additional leverage to the handler.

In preferred embodiments, and as illustrated in the figures, the frame assembly includes a supporting stand 19 protruding downwardly which provides support and stability to the frame assembly and keeps it level during operation.

Preferably, the weight of the apparatus is distributed across the axle such that it is slightly heavier toward the front end when the apparatus is not loaded with chemicals, thereby stabilizing the apparatus on the wheels and the supporting stand. The pedal 17 provides a leverage point that allows the handler to tip the frame assembly to balance the apparatus on the wheels for transport.

Containers and Suction Assembly

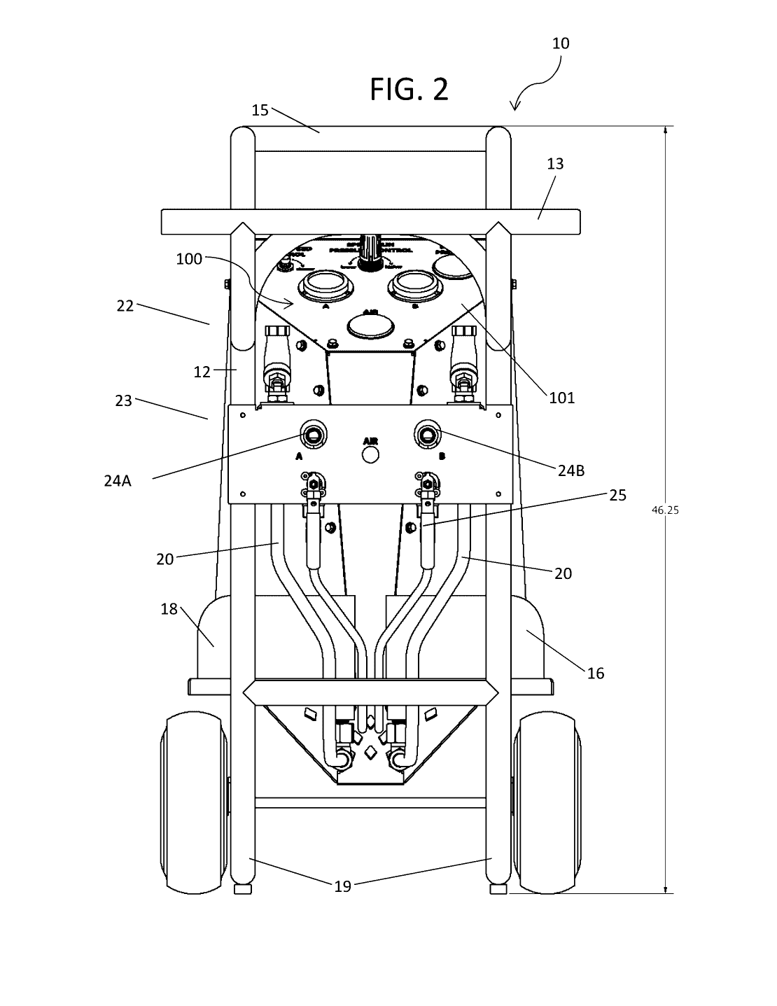

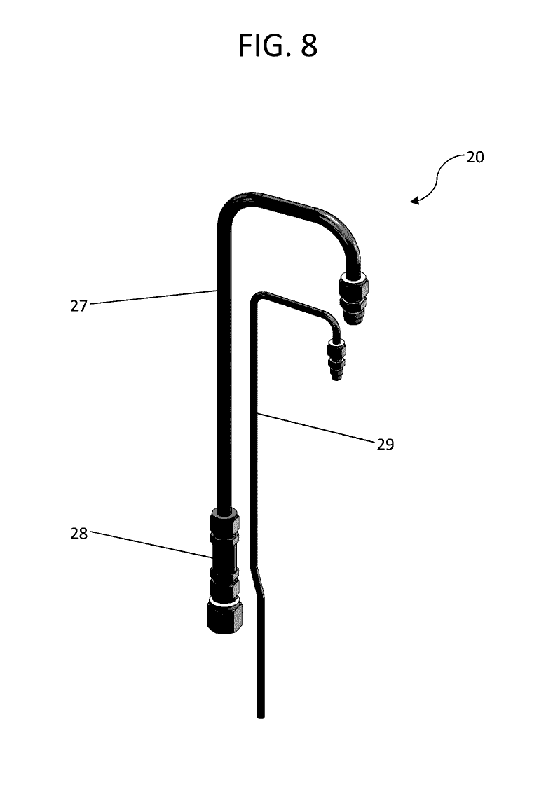

The apparatus includes two suction hose assemblies that vacuum the reagents from the containers. As shown in FIG. 8, each suction hose assembly is composed of a suction tube 27 with a submerged check valve 28, and a recirculation tube 29, which is used to purge air from the suction hose assembly. The suction tube and recirculation tubes are connected to the apparatus at the pump 30 through the use of high pressure, Teflon-lined stainless steel flex hose (not shown in drawings). The hoses connect into the pump 30 at the bottom of the fluid section. The recirculation is controlled by recirculation valves 25 (FIG. 1). The reagent hoses are connected at the reagent hose connections 24A, B (FIG. 2).

Pump

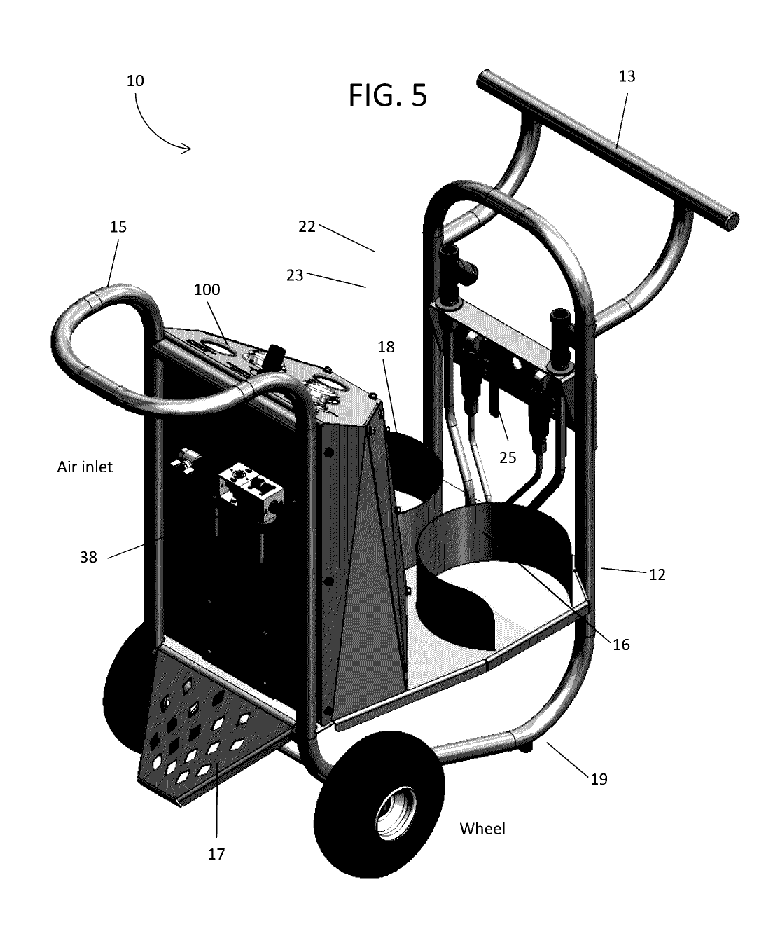

The pump 30, shown in FIGS. 4 and 5, pumps the reagent materials from the containers through the hoses to the gun. The pump is a high-precision, variable-speed air pneumatic pump. In a preferred embodiment, the pump is a positive displacement pump design that delivers a highly precise ratio control of ±0.1%. The fixed ratio pump has been specifically designed to mix and dispense multiple 1:1 volumetric materials. The air pneumatic pump is designed to mix and dispense viscous material through a gravity feed system that eliminates the need for transfer pumps. The air pneumatic system delivers a 15:1 pumping ratio, with a mixing ratio of 1:1 with an average air consumption of 10 to 15 CFM. The material displacement of each side of the fluid section of the pump has a 19.30 cc capacity.

Other pumps were tested but found to be unsatisfactory because the mixing tolerance was too great, creating foams that were greatly different from the desired reagent component ratio, which resulted in slow curing and significant off-gassing because the excess component would not react and solidify, but rather would evaporate. When accurately mixed, the spray foam reacts completely and cures rapidly, creating a fast-sealing barrier that is usable soon after application.

The pump is preferably a variable-speed, air pneumatic pump. The variable speed provides for adjustment by the operator to allow a more even application. The pneumatic power also provides for more consistent application; again creating a more even layer.

Air Supply

The high-pressure air supply, generally shown as 31 in FIG. 7, is provided by an air compressor 33 with air tank cylinders 34. Preferably, the high-pressure air supply delivers between 100-150 psi at 15-18 CFM during the cycling of the pump. The air supply is preferably cleaned with a two-stage filtration system FIG which includes a water separator 38 and an oil coalescing filter 39. The air filter cleans particulate down to 10 microns while the oil filter removes aerosols down to 0.001 ppm.

The air compressor is preferably portable, rugged and built with cast iron cylinders. It should have a lead an 8-10 gallon twin tank capacity so that when the air is fed to the pump it provides consistent air supply on the pump so that the chemicals are proportioned at a 1:1 ratio or as close to that ratio as possible.

The use of a portable compressed air compressor allows the operation of the apparatus to also provide increased portability because the pump is being supplied with clean, consistent and adjustable air. Also, because the air pressure on both the air compressor and the apparatus are adjustable, it is possible to adjust the entire system according to the weather conditions that the sealant is being applied in. Because the sealant chemicals must adjust to humidity, substrate temperatures and even building conditions, it is important for the entire system to have some built-in flexibility which is what the integrated air compressor and filter system gives to the apparatus.

Hose Assembly and Hose Wrap

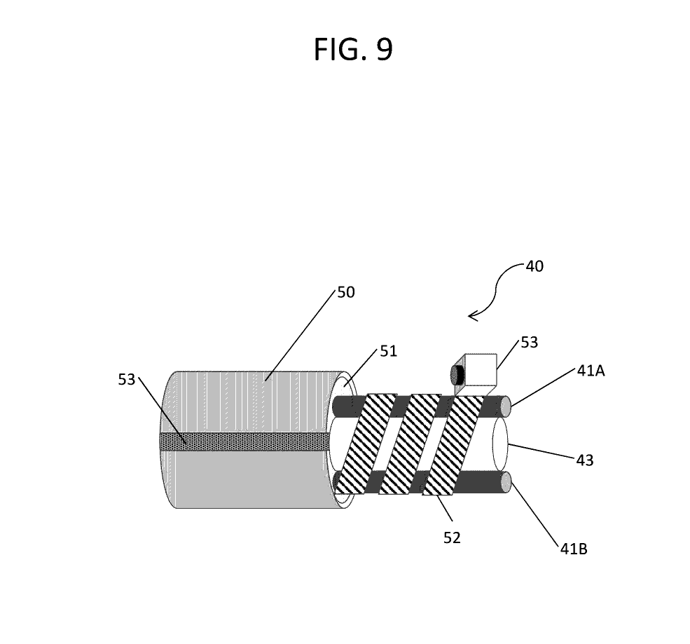

A spray hose assembly, generally described as 40 in FIGS. 7 and 9, includes reagent hoses 41A, 41B, a pressurized air hose 43; a heat tape 52 with a temperature regulator 53; and a protective wrap 50 with insulation 51. The protective wrap is preferably held closed by hook-and-loop fasteners 53. The reagent hoses 41A, B are attached at a first end to the pump 30 and at a second end to an impingement-mixing spray gun 70 (FIG. 7). The reagent hoses connect at the reagent hose connections 24A, B (FIG. 2).

The spray hose assembly has a preferable length of not less than 50′ but has the capacity to extend to 300+′ depending upon the application. An optimum length used when spraying in existing residential houses is 100′ which is conveniently be mounted on the front of the apparatus for easy storage and mobility. The hose wrap as described in FIG. 9 is preferably capable of maintaining up to 3,000 psi of chemical pressure, 180 psi of air supply pressure and maintains at least 120 degrees F. of air and/or hose temperature. This assembly should also have a very lightweight, tough and highly flexible exterior surface with a temperature range of −60 degrees F. to 225 degrees F. The entire sleeve that contains the chemical hose, air hose and heat tape are easy to install and repair and contain a low co-efficiency so that it resist wear. Ideally the sleeve should be constructed of a MilSpec urethane coated 1050 Ballistics Nylon.

The present invention is designed and configured to proportion 1:1 ratio chemicals like closed-cell spray foam, open-cell spray foam, polyurethane sealants or polyurea coatings. To achieve this, the system applies the reagents at a high temperature, preferably above 120 degrees F. By applying the reagents at a higher temperature, the reaction of the chemicals is faster, thereby reducing off-gassing and creating a substrate that would have a very long life cycle of up to 30 years.

When the ambient temperature is below the desired reagent reaction temperature, the protective wrap 50 includes insulation 51, a heat tape 52 and heat regulator 53. For example, polyurethane is difficult to spray in winter, because the unreacted chemicals need to be at least above 26 degrees C. (about 80 degrees F.) for optimum chemical reaction, and therefore the spray hose assembly is equipped with a thermal warp.

Preferably, the temperature of the heat tape 52 is adjustable from about 50 degrees F. to up to 450 degrees F. by the heat regulator 53. The insulated wrap 51 retains the heat provided by the heat tape 52. About 10 feet (about 3 meters) of heat tape is sufficient for 50-100 feet (about 15-30 meters) of hose because the temperature of the spray hose assembly is maintained by the insulated wrap. The heat tape is wrapped in about the first 5 ft. (about 1.5 m) of the spray hose assembly; which is 1/10 or ⅕ the length of a 100 ft. or 50 ft. spray hose assembly, respectively.

Spray Gun

The function of the spray gun is to mix the “A” and the “B” components and discharge the mixture in a uniform spray pattern. The trick with spray guns is to mix and spray out the “A” and “B” components without the mixed material reacting in or on the gun. Different guns employ different strategies to accomplish this. Elements include hose connections, material shut off valves, material screens, mixing chambers, spray tips and a trigger. The guns are “air purge” or a “mechanically purged”.

Plural component spray guns operate by mixing the “A” and the “B” components at a high velocity and discharging the mix out of the spray time or nozzle. This direct impingement mixing relies on the kinetic energy of the two materials rather than on moving parts. Mixing requires controlled and constant material viscosities (which is a function of temperature) and pressures to effect the proper mix and spray patterns.

The material delivery hose is connected to one or two hose connection blocks. The connection block allows for disconnecting the gun assembly from the hose for easier maintenance and safe gun storage. Connection blocks have material shut off valves, check valves (to hinder back flow and crossover) and material filter screens to remove small particulates which might clog the gun orifices.

The spray gun is preferably less than 2 lbs. in weight and has a small profile as much of the spraying will be in difficult-to-reach areas. The spray gun will also be using a mechanical purge system as this provides a very reliable delivery system since there will be a lot of triggering of the gun. It is also very important to have a spray gun that is very simple to operate, set up and maintain. Finally, the rebuild costs of the gun should be inexpensive and take very little time to complete.

The parameters of the spray gun that will be used by the apparatus include an air requirement of 80-130 PSI. A maximum fluid temperature of 200 F and a maximum fluid working pressure of 3,500 psi.

Controls & Indicators

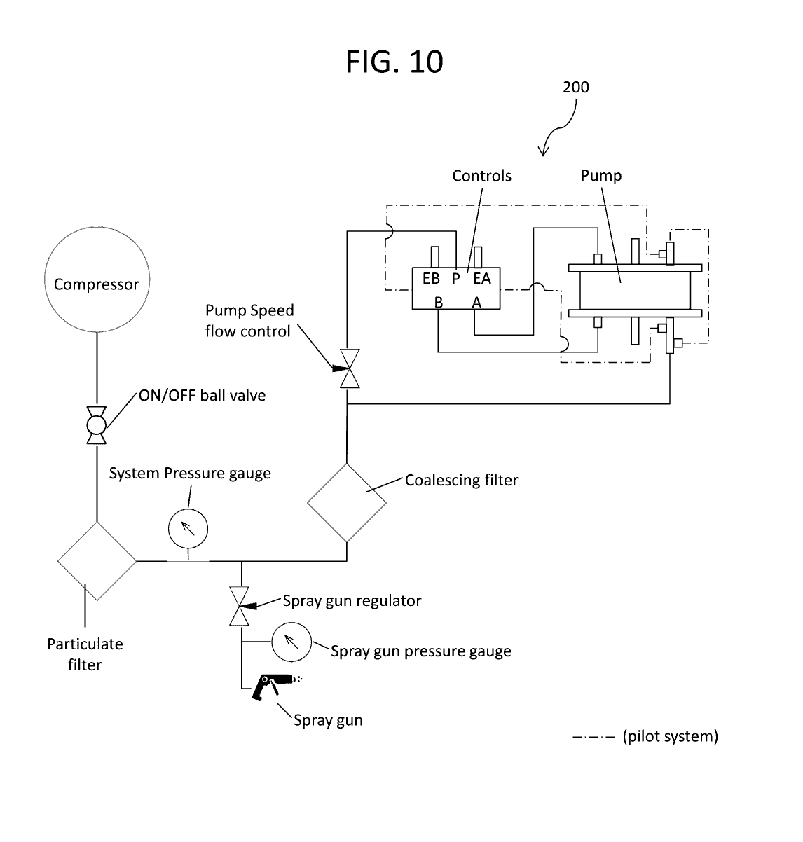

The controls, generally described as 100 in FIGS. 1, 2 and 6 and also shown schematically in FIG. 10 are housed on the control panel 101. The controls include the pump speed control 102 and the spray gun air pressure control regulator 103. The indicators include inbound air pressure from the air compressor 104, air pressure to the pump 106 and pressure coming out of both pump discharge ports of the reagent that is being provided to the spray gun. The pressure for the pump A is 105A and that for pump B is 105B.

The apparatus preferably weighs less than about 260 lbs (118 Kg) when loaded, such that it is moveable by a single person.

Suction Hose Assembly

The suction hose assembly FIG. 8 for the apparatus allows for a reliable supply of reagent from the 5 gallon buckets. The suction hose assembly consists of two components. One is the suction hose 27 which is built out of stainless steel tubing, a stainless steel check valve, a stainless steel mud daber and tube fitting to connect to the suction hose. The bypass assembly 29 consists of stainless steel tube with a stainless steel tube fitting.

Both the suction assembly 27 and the bypass assembly 29 work together to not only feed the air pneumatic pump with reagents but also it allows for the operator to purge the piping from air bubbles which could be introduced when the chemical buckets are changed. The check valve at the base of the suction assembly also prevents additional air from entering into the chemistry.

The entire suction assembly 27 & 29 is sized so that it will fit into a 5 gallon plastic pail spout without damaging it. This allows for the suction assembly to be use with almost any 5 gallon pail manufacturer in the United States. Also, the suction hose assembly is universal so it can be used on either the “A” side or the “B” side of the air pneumatic pump. The suction hose assembly was designed and tested to operate specifically with the apparatus.

### Frame & Cart

The frame and cart is designed to be light, portable, durable and have the ability to integrate all of the components to that they function correctly together. Because of the abrasive nature of the raw chemicals, it will be important that the frame be made of a very resistant metal such as stainless steel or aluminum. The frame is structurally strong to allow it to carry the two 5 gallon pails which could weigh up to 50 lbs each and to withstand the abusive environment that is often associated with construction.

The cart is designed into the frame in such a way that allows the entire spray machine to be balanced while it is being moved. The wheels and axles are machined into the frame so that it withstands shocks if the entire spray machine is dropped or pulled upon rough terrain.

The frame also includes a cabinet or enclosure which will act as a protection from the operators and the moving parts of the air pneumatic pump. The cabinet also houses all of the air compression fittings and high pressure hoses which are attached to the gauges. This protects the operator from any potential blow out of the hose should one of the fittings come loose or disconnected because of wear and tear.

OCF Insulating Foam Sealant Application

As energy efficiency continues to grow in importance, so does the use and knowledge of spray polyurethane foam (SPF) for the weatherization contractor/professional. The present invention provides spray applications for the weatherization professional, meaning a contractor working on a job hired to install a particular kind of SPF called low pressure one-component foam (OCF) or “foam in a can”.

OCF sealants are intended for use in a “bead type” application for air sealing or adhering. Their small volume, ease of use, and portability make them ideal for smaller projects tackled by weatherization professionals. Because the invention is a multi-foam spray apparatus, it also applies low pressure foam (FIG. 7) through the high pressure air compressor system 31. In this embodiment, a one-component foam canister 110 is attached via a valved connector 115 to a low pressure gun assembly 100 which includes a 100′ air hose and the spray gun.

The spray gun has been modified to include a connection for a one-component foam canister that will allow the invention to apply one-component foam (OCF) which is pressurized in cans and is designed to be applied as a bead to now be sprayed with an adjustable nozzle pattern. This allows the insulating foam sealant to be used in to insulate and air seal small to mid-size areas around the home, such as air duct boots, attics, crawl spaces and rim joists. This allows the invention to provide a wide array of air sealing opportunities that would normally be addressed with much more expensive low-pressure two component SPF kits or refillable tanks.

No-Heat Foam

The present invention is also designed and configured to apply spray foams that do not require elevated reaction temperatures. For example, the present invention is designed and configured to apply the QuadFoam® RetroSeal® 2.0 SPF system, which has a preferred reaction temperature of about 105 to about 135 degrees F.

Fire-Resistant Foam

The present invention also provides for applying fire-resistant foams. For example, FireSkin Foam, manufactured by SuperSkinSystems Inc, is an insulating material designed to withstand direct flame contact. It produces very low smoke and flame spread. The material develops an intumescent fire barrier which provides a protective shield against constant flame and extreme heat conduction to interior surfaces. These closed cell foams range in densities from 1.5-50 pcf for use in diverse fire protection system applications. FireSkin Foam is formulated as a Halogen-free, Class 1 fire rated foam containing renewable resource “Green” materials.

FireSkin Foam delivers toughness and dimensional stability from −20 F (−29 C) to 250 F (130 C). It is used in a variety of construction applications such as in roof, wall and floor building insulation and structural sandwich panel construction foam core materials. These materials have been designed to accommodate HFC 245 or Pentane blowing agent for maximum R-values. This material has been designed for use in economical Continuous Panel Laminator machines as shown below.

FireSkin Foam is a two component 100% solids spray formulation which does not contain VOCs. This material may require the use of a primer to obtain proper adhesion on certain substrates. All surfaces must be clean and free of contaminates and no moisture. Application temperature ranges from 50° F. to 120° F. Gel Time is adjusted to fit application. Typically, gel is 8-10 sec at 75° F. with full cure in 24 hours. Use standard 1:1 high pressure plural component spray machine. Functional operation temperature ranges from −40° F. to 300° F. Application spray thickness should be based on continuous build. Foam coverage depends directly density, temperature of substrate, material and ambient conditions.

Methods

Method steps for using the system and/or apparatus of the present invention include: providing a system with at least two materials in separate material containers positioned within the container holders; and activating the high-precision ratio control pump for pumping the materials from the containers through the hoses; and activating the spray gun to apply the foam. Additional steps included heating the delivery hoses with a thermal hose wrap.

Applications

Accurate and precise mixing is critical to ensure that a high-density layer has adequate and uniform air barrier properties. Furthermore, the higher temperature of application increases the rate of reaction of the reagents. Thus, the multiple components of the system and apparatus are critical for precisely controlling the mixing to ensure quick curing, proper density, uniform consistency, and minimal off-gassing. Starting with the air supply, it is provided by a high-pressure compressed air tank, thereby providing air at a uniform pressure, without the variability that comes from using air directly from a compressor. Next, the air filter removes particulates, preventing the obstruction of the system and variability in the sprayed barrier from contaminants. The mixing pump is a high-precision ratio control pump, thereby tightly controlling the ratio of reagents, which reduces off-gassing, promotes faster curing, and maintains uniformity and proper density. The suction assembly provides for purging of air bubbles from the supply hose, thereby increasing uniformity. The heated delivery hose provides reagents at an optimal reaction temperature, thus increasing the rate of reaction and reducing the time reagents have to evaporate. Finally, the controls provide for fine-tuning the application, thereby preventing over-application. The apparatus has only two controls, both designed to regulate air. The regulation to the pneumatic pump 103 is used the control the speed of the reagent liquid as it travels through the pump to the gun. The higher the pressure, the better the 1:1 ratio mix on the chemistry. Also, the ability to lower the pressure with the right application allows the spray gun to meter the chemicals and create a mist type of application.

The air regulator 102 on the spray gun allows for a more precise air control to keep the gun clean of debris and dirt. This keeps the spray gun operational for a longer period of time without having to stop and clean the tip.

The ability to control both the pneumatic pump and the spray gun allows also for changes in viscosity of the various chemicals that will be used. This air regulation also allows the operator to adjust to changes in the ambient temperature of area being sprayed. If there is a warmer climate with high humidity, then the pump and gun air controls are adjusted to that condition. The same with colder weather as the ambient temperature negatively affects the viscosity of the chemicals and the condition of the air that is being supplied to the apparatus.

Advantageously, the apparatus provides for the creation of sealant material at various densities, including low, medium and high-density. The densities range from about 96 kg/m³ (about 0.5 lbs/board ft) for low-density foams to about 960 kg/m3 (about 5 lbs/board ft) for high-density foams.

### Example

A high-density foam application is provided as an example. A high-density setting provides foam at a density of about 961 kg/m³ (about 5 lbs. per 12″×12″×1″ block [5 lbs./board ft.]; about 60 lbs./cu.ft.). This setting provides for the creation of high-density, low-thickness foams that are used for air barrier applications. The foam is applied at a minimum of about ¼ inch to a maximum of about ¾ inch.

Another good example of the unique capacity of the present invention is its ability to apply a 2 lb closed cell spray foam that would qualify as an air barrier. Based upon good building science, one of the very best air barriers for any building material to use about 1″ of closed cell spray foam. This is because at that thickness, testing proves that air cannot penetrate through the material. That application currently only exists in the commercial building market. The apparatus would be able to apply this spray technology for the existing residential housing market at a price point that would be affordable.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A precision spray apparatus, comprising:
a portable frame assembly, at least two suction hose assemblies, at least one air filter, a precision mixing pump, and a control panel housing controls;
wherein the frame assembly includes wheels, container holders, front and rear handles, a pedal, and at least one supporting stand;
wherein the suction hose assembly includes a suction tube, a check valve, and a recirculation tube;
wherein the precision mixing pump is an air pneumatic mixing pump;
wherein the controls are pump speed control and spray gun pressure control; and
wherein the frame assembly provides a support frame for the other components, the suction hose assemblies are hydraulically connected to the mixing pump, the mixing pump is connected pneumatically connected to a compressed air supply.

2. The apparatus of claim 1, wherein the mixing pump has a mixing ratio control of less than about 0.1%.

3. The apparatus of claim 1, further including a spray hose assembly and an impingement mixing spray gun;
wherein the spray hose assembly includes reagent hoses and a compressed air hose; and
wherein the spray hose assembly is connected hydraulically to the mixing pump and hydraulically and pneumatically to the spray gun.

4. The apparatus of claim 3, further including a protective wrap with insulation for the spray hose assembly.

5. The apparatus of claim 4, further including a heat tape in the spray hose assembly.

6. The apparatus of claim 1, further including at least one pressure indicator selected from the group consisting of system pressure and reagent pressure.

7. The apparatus of claim 1, further including a hose temperature indicator.

8. The apparatus of claim 1, further including a spray gun regulator with a foam density indicator with a range from about 0.5 lbs/board ft to about 5 lbs/board ft.

9. The apparatus of claim 1, further including a spray gun regulator with a foam density indicator with a range of about 96 kg/m³ to about 960 kg/m³.

10. The apparatus of claim 1, further including a low-pressure, one-component foam applicator.

11. A system for applying an air barrier layer comprising:
a portable frame assembly, at least two suction hose assemblies, at least one air filter, a precision mixing pump, a control panel housing controls, a high-pressure air supply; a spray hose assembly and an impingement mixing spray gun;
wherein the frame assembly includes wheels, container holders, front and rear handles, a pedal, and at least one supporting stand;
wherein the suction hose assembly includes a suction tube, a check valve, and a recirculation tube;
wherein the precision mixing pump is an air pneumatic mixing pump;
wherein the controls are pump speed control and spray gun pressure control; and
wherein the frame assembly provides a support frame for the other components, the suction hose assemblies are hydraulically connected to the mixing pump, the mixing pump is connected pneumatically connected to a compressed air supply.
wherein the spray hose assembly includes reagent hoses and a compressed air hose; and
wherein the spray hose assembly is connected hydraulically to the mixing pump and hydraulically and pneumatically to the spray gun;
and wherein the high-pressure air supply is between about 2,000 to 3,000 PSI.

12. The system of claim 11, wherein the air supply is an air tank.

13. The system of claim 11, wherein the mixing pump has a mixing ratio control of about 0.1%.

14. The system of claim 11, further including a protective wrap for the spray hose assembly.

15. The system of claim 14, further including a heat tape in the spray hose assembly.

16. The system of claim 11, further including at least one pressure indicator selected from the group consisting of system pressure and reagent pressure.

17. The system of claim 11, further including a hose temperature indicator.

18. The system of claim 11, further including a spray gun regulator with a foam density indicator with a range from about 0.5 lbs/board ft to about 5 lbs/board ft.

19. The system of claim 11, further including a spray gun regulator with a foam density indicator with a range of about 96 kg/m³ to about 960 kg/m³.

20. The system of claim 11, further including a low-pressure, one-component foam applicator.
